(19) United States
(12) Patent Application Publication
(10) Pub. No.: US 2011/0048379 A1
(43) Pub. Date: Mar. 3, 2011

(54) FLUID INJECTOR WITH RATE SHAPING CAPABILITY

(75) Inventors: Mark F. Sommars, Hopewell, IL (US); Hoisan Kim, Dunlap, IL (US); Dennis Gibson, Chillicothe, IL (US)

(73) Assignee: Caterpillar Inc., Peoria, IL (US)

(21) Appl. No.: 12/552,523

(22) Filed: Sep. 2, 2009

(51) Int. Cl. F02M 69/46; F02M 41/16

(52) U.S. Cl. 123/456; 239/96

(57) ABSTRACT

A common rail single fluid injection system includes fuel injectors with one or two control valve assemblies with the ability to produce ramp, square and split injection rate shapes. This is accomplished by including a check speed control device disposed between a first and second check control chamber within a cavity defined by the injector body. The control valves and check speed control device control the speed of a check by controlling the flow of fuel out of the first and second check control chambers.

### TECHNICAL FIELD

The present disclosure relates generally to a single fluid fuel injection system, and more particularly to fuel injection systems with rate shaping capabilities.

### BACKGROUND

Engines, including diesel engines, gasoline engines, natural gas engines, and other engines known in the art, exhaust a complex mixture of combustion related constituents. The constituents may be gaseous and solid material, which include nitrous oxides (NOx) and particulate matter. Due to increased attention on the environment, exhaust emission standards have become more stringent and the amount of NOx and particulate matter emitted from an engine may be regulated depending on the type of engine, size of engine, and/or class of engine.

Engineers have come to recognize that undesirable engine emissions, such as NOx, particulate matter, and unburnt hydrocarbons, can be reduced across an engine's operating range with fuel injection systems with maximum flexibility in controlling injection timing, flow rate, injection quantity, injection rate shapes, end of injection characteristics and other factors known in the art. The desire for maximum flexibility is often tempered by the need to manage costs associated with fuel injection system components and manufacturability, the need for a robust system, the desire to reduce performance variations among fuel injectors in a system, and other factors known in the art. These issues were initially addressed by introducing an electrical actuator into fuel injectors in order to gain some threshold controllability over injection timing and quantity independent of engine crank angle. In the case of common rail fuel injection systems, this threshold control is often accomplished either by including an electronically controllable admission valve or an electronically controllable direct control needle valve. In the former case, the fuel injector's nozzle chamber is opened and closed to a fluid connection with the high pressure fuel rail by opening and closing an admission valve via an electrical actuator. In some instances, the admission valve is directly coupled to an electrical actuator, such as a solenoid, and in other instances the admission valve is pilot operated. In other common rail fuel injection systems, the nozzle chamber remains fluidly connected to the high pressure rail at all times, but the nozzles are opened and closed by relieving pressure on a closing hydraulic surface of a direct control needle valve. Although these common rail fuel injection systems have many desirable aspects, the ability to maximize flexibility in injection characteristics has remained elusive.

In one example common rail fuel injector disclosed in U.S. Pat. No. 5,984,200 to Augustin, a pilot operated admission valve supposedly includes features that allow the fuel injector to provide a relatively slow rate of injection toward the beginning of an injection event to produce what is commonly referred to in the art as a ramp shaped injection event. While it is true that ramp shaped injection events have proven effective in reducing undesirable emissions at some engine operating conditions, other engine operating conditions often demand different injection characteristics to effectively reduce undesirable emissions. Among these other desired injection characteristics are split injections, the ability to produce square front end injection rate shapes, and the ability to abruptly end injection events. Thus, it has proven problematic to produce common rail fuel injectors with an expanded range of capabilities.

The disclosed fuel injector with rate shaping capability is directed to overcoming one or more of the problems set forth above.

### SUMMARY OF THE DISCLOSURE

In one aspect, a fluid injector includes an injector body defining a high-pressure inlet, a nozzle supply passage, a low pressure drain and at least one nozzle outlet. A check speed control device having an upper surface, lower surface, and an orifice, positioned within a cavity of the fluid injector having an upper surface and a lower surface. The space between the upper surface of the check speed control device and upper surface of the cavity defines a first check control chamber. The space defined by the lower surface of the check speed control device and the lower surface of the cavity defines a second check control chamber. The first and second check control chambers are in fluid communication with one another via the orifice. The check speed control device is movable within the cavity between a first speed control position wherein at least a portion of the upper surface of the check speed control device is in contact with the upper surface of the cavity, and a second speed control position wherein at least a portion of the upper surface of the check speed control device is spaced away from the upper surface of the cavity. A control valve assembly having a valve member configured to selectively connect the high pressure inlet, the low pressure drain and first check control chamber. A check movable within the fluid injector between a first check position at which the check blocks the at least one nozzle outlet and a second check position at which the check at least partially opens the at least one nozzle outlet. The check further including at least one opening hydraulic surface exposed to a fluid pressure of the nozzle supply passage, and at least one closing hydraulic surface exposed to a fluid pressure of the second check control chamber.

In another aspect, a method of controlling a speed of a check in a fluid injector includes a step of providing a fluid injector having a cavity wherein said cavity includes an upper surface and a lower surface. A check speed control device having an upper surface, lower surface, and orifice, positioned within the cavity is also provided. The space between the upper surface of the check speed control device and the upper surface of the cavity defines a first check control chamber, and the space between the lower surface of the check speed control device and the lower surface of the cavity defines a second check control chamber. The first check control chamber and second check control chamber are fluidly connected to one another via the orifice. The check speed control device is movable within the cavity between a first speed control position wherein at least a portion of the upper surface of the check speed control device is in contact with the upper surface of the cavity and a second speed control position wherein at least a portion of the upper surface of the check speed control device is spaced away from the upper surface of the cavity. A check having a first check end and a second check end is also provided. The check is movable a check travel distance defined as a distance between a first check position wherein the first check end blocks a nozzle outlet of the fluid injector, and a second check position at which the first check end at least partially opens the nozzle outlet. The second check end includes at least one closing hydraulic surface, and is exposed to a fluid pressure of the second check control chamber. The speed of the check is limited over the check travel distance with the check speed control device, which controls the rate of fluid expelled from the cavity to a low pressure drain of the fluid injector.

In another aspect, an internal combustion engine includes an engine housing defining a plurality of engine cylinders, and a plurality of pistons each being movable within a corresponding one of the engine cylinders. A fuel system including a plurality of fuel injectors associated one with each of the plurality of engine cylinders, each of the fuel injectors including a cavity having an upper surface and a lower surface, and having a check speed control device having an upper and lower surface and an orifice positioned therein. The space between the upper surface of the check speed control device and the upper surface of the cavity defines a first check control chamber, and the space between the lower surface of the check speed control device and the lower surface of the cavity defines a second check control chamber. The first and second check control chambers are fluidly connected to one another via the orifice. Each of the plurality of fuel injectors further includes a check movable a check travel distance to control an injection of fuel into the associated engine cylinder and at least one closing hydraulic surface exposed to a fluid pressure of the second check control chamber.

### BRIEF DESCRIPTION OF THE DRAWINGS

FIG. 1 is a diagrammatic schematic of a fuel system using a common rail fuel injector;

FIG. 2 is a cross section of a common rail fuel injector utilizing a check speed control device;

FIG. 3 is an inset of the injector of FIG. 2 showing the detail of one embodiment of the check speed control device;

FIG. 4 is a plan view of an exemplary check speed control device;

FIG. 5 is a graph depicting various injection rate delivery curves;

FIG. 6 is a cross section of a nozzle assembly with an alternate embodiment of the check speed control device;

FIG. 7 is an inset of the nozzle assembly of FIG. 6 showing the detail of the alternate embodiment of the check speed control device;

FIG. 8 is a schematic of a cross section of an alternate embodiment of a common rail fuel injector utilizing a check speed control device.

### DETAILED DESCRIPTION

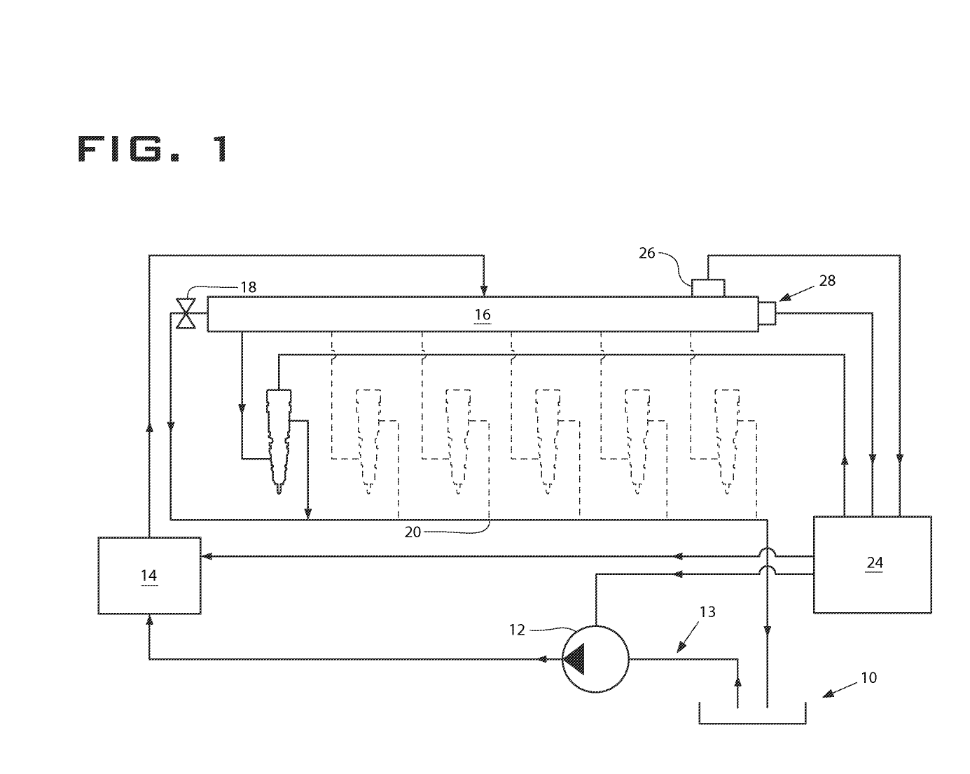

Referring to FIG. 1, a fuel system utilizing a common rail fuel injector 22 is shown. A reservoir 10 contains fuel at an ambient pressure. A transfer pump 12 draws low-pressure fuel through fuel supply line 13 and provides it to high-pressure pump 14. High-pressure pump 14 then pressurizes the fuel to desired fuel injection pressure levels and delivers the fuel to the fuel rail 16. The pressure in fuel rail 16 is controlled in part by safety valve 18, which spills fuel to the fuel return line 20 if the pressure in the rail 16 is above a desired pressure. The fuel return line 20 returns fuel to low-pressure reservoir 10.

Fuel injector 22 draws fuel from rail 16 and injects it into a combustion cylinder of the engine (not shown). Fuel not injected by injector 22 is spilled to fuel return line 20. Electronic Control Module (ECM) 24 provides general control for the system. ECM 24 receives various input signals, such as from pressure sensor 26 and a temperature sensor 28 connected to fuel rail 16, to determine operational conditions. ECM 24 then sends out various control signals to various components including the transfer pump 12, high-pressure pump 14, and fuel injector 22.

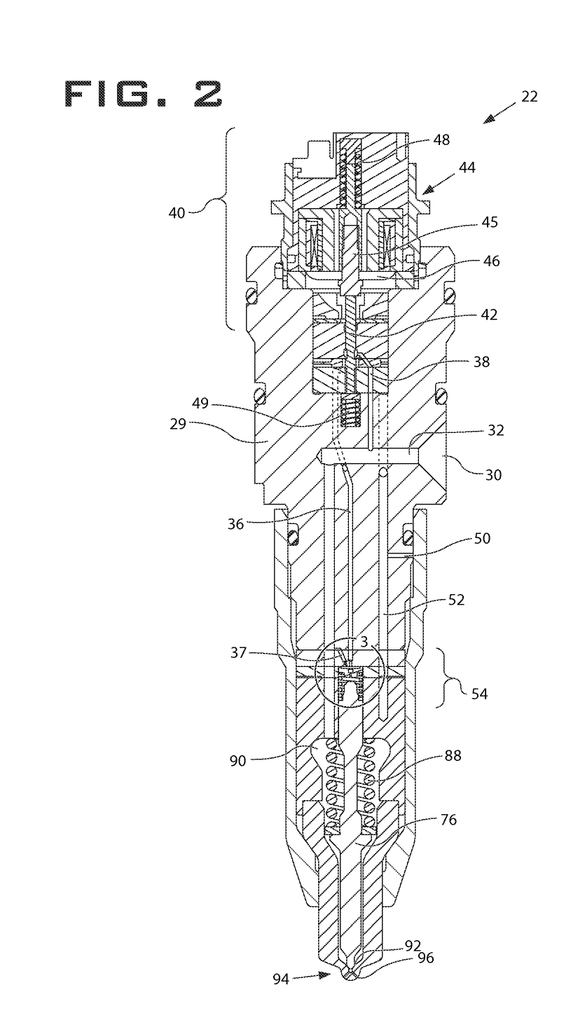

Referring to FIG. 2, the internal structure and fluid circuitry of each fuel injector 22 is illustrated. In particular, an injector body 29 defines a high-pressure fuel supply inlet 30 and a fuel supply passage 32, which are interconnected. Fuel supply passage 32 is in fluid communication with nozzle passage 34. Fuel supply passage 32 is also in fluid communication with check control line 36 via control valve supply line 38 and a control valve assembly 40. The operation of the fuel injector 22 is controlled by at least one control valve assembly 40, that includes a control valve member 42 that moves between a low pressure seat (not shown) and high pressure seat (not shown). In the embodiment shown control valve assembly 40 further includes a piston 45 coupled to an armature 46. Piston 45 is operably coupled to electrical actuator 44, through armature 46. Piston 45 and armature 46 are normally biased downward by a biasing spring 48. In the embodiment shown, control valve member 42 is in turn, biased downward to close low-pressure seat. When control valve member 42 is in a downward position closing low pressure seat, check control line 36 is in fluid communication with fuel supply passage 32 via control valve supply line 38. When electrical actuator 44 is energized, the electromagnetic field generated by the electrical actuator 44 causes armature 46 and piston 45 to lift by overcoming the downward force applied by biasing spring 48. When the downward force applied by biasing spring 48 and piston 45 is removed from control valve member 42, another smaller biasing spring 49 positioned beneath the control valve member 42 lifts it upwards to close high pressure seat. When the high pressure seat is closed, check control line 36 is fluidly connected to drain outlet 50 via drain passage 52. It will be appreciated by those skilled in the art that control valve assembly 40 could have many alternate embodiments without deviating from the scope and spirit of this disclosure. These alternate embodiments may include piezo actuation and other armature, spring, and control valve member configurations.

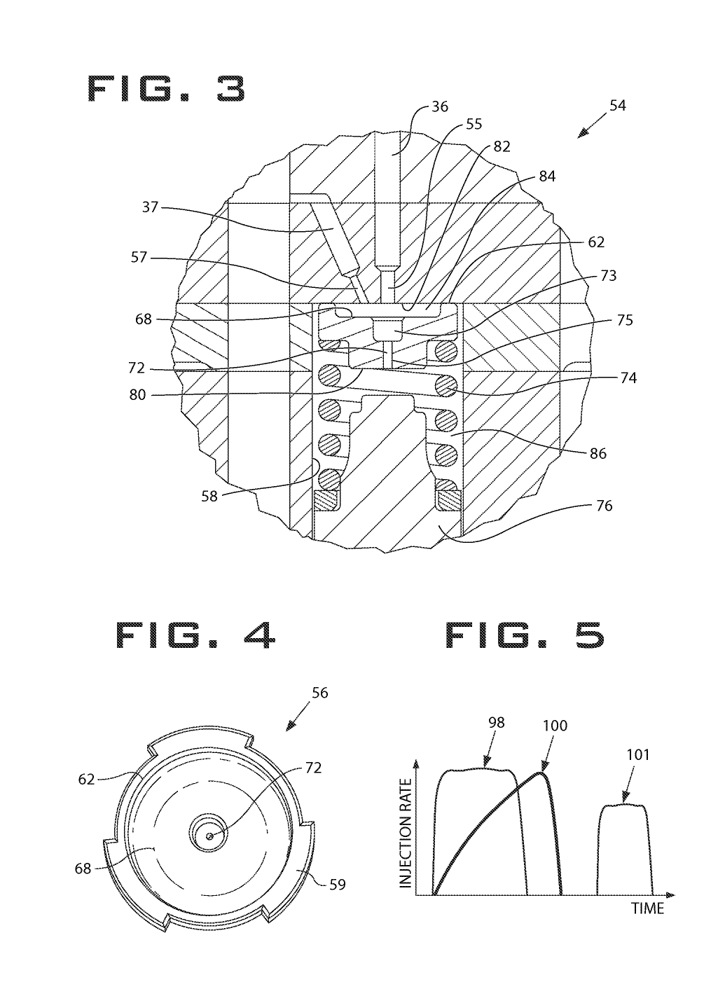

Referring now to FIGS. 2 and 3, check control line 36 and high-pressure branch passage 37, are fluidly connected to a check speed control assembly 54 via an a-orifice 55 and a z-orifice 57, respectively. Check speed control assembly 54 includes a check speed control device 56 disposed within a cavity 58 defined by injector body 29. Check speed control device 56 may be generally disc-shaped and may include an upper raised surface or lip 62 around its periphery. Lip 62 has a predetermined width and is raised a predetermined height from an upper surface 68. Upper surface 68 has an orifice 72 that is capable of providing fluid communication through the check speed control device 56. It is contemplated that the orifice 72 may be centrally located on upper surface 68 any may be restricted or tapered such that it is wider at its top than at its bottom. In the embodiment shown in FIG. 3, orifice 72 has a relatively wide tube-shaped upper portion 73 and a relatively thin tube shaped bottom portion 75. As shown in FIG. 4, check speed control device 56 may also have one or more radial guides 59. The outer edges of the radial guides 59 may be contact with the side walls of cavity 58. The radial guides 59 may be spaced apart from one another around the periphery of check speed control device 56.

As shown in FIG. 3, the check speed control assembly 54 may also include a biasing spring 74 disposed between a check valve 76 and the check speed control device 56. The biasing spring 74 biases the check speed control device 56 in an upward direction such that the lip 62 of the check speed control device 56 is in contact with the upper surface 82 of cavity 58. A first check control chamber 84 is defined by the upper surface 82 of the cavity 58 and the upper surface 68 of the check speed control device 56. A second check control chamber 86 is defined by the bottom surface 80 of the check speed control device 56 and the space of cavity 58 above check 76. The check speed control device 56 is movable within cavity 58 between a first position wherein lip 62 is in contact with the upper surface 82 of cavity 58, and a second position wherein lip 62 is out of contact with upper surface 82.

The operation of injector 22 will now be explained. The opening and closing of check 76 is controlled in part by the presence of high-pressure fuel in nozzle passage 34, check control line 36, and high-pressure branch passage 37. Check spring 88 and check speed control device 56 also play a role in the opening and closing of check 76. When an injection event is not desired, control valve assembly 40 is not energized. High-pressure fuel enters injector 22 through high-pressure fuel inlet 30. Pressurized fuel is provided to control valve assembly 40, via control valve supply line 38. In its deenergized state, control valve assembly 40 provides fluid communication between control valve supply line 38 and check control line 36. Thus, high-pressure fuel is provided to the first check control chamber 84 via check control line 36 and the a-orifice 55. Pressurized fuel is also provided to the first check control chamber 84 via nozzle passage 34, high-pressure branch passage 37, and z-orifice 57. At least a portion of the high-pressure fuel that enters the first check control chamber 84 flows through orifice 72 and into the second check control chamber 86. Pressurized fuel also reaches the second check control chamber 86 because as pressure builds in the first check control chamber 84, the check speed control device 56 overcomes the force of biasing spring 74 and lip 62 unseats at least partially from the upper surface 82 of cavity 58. As lip 62 unseats, fluid communication between the first and second check control chambers 84, 86 is provided via the one or more spaces in between the radial guides 59. Once high-pressure fuel fills the first and second check control chambers 84, 86, the pressure within the chambers equalizes and biasing spring 74 returns the check speed control device 56 to its first position. High-pressure fuel is also provided to a nozzle cavity 90 via nozzle passage 34.

The high-pressure fuel that is provided to nozzle cavity 90 seeks to unseat check 76 by applying hydraulic pressure to various surfaces to the check 76. These forces seek to lift check 76 off of its seat 92. However, when control valve assembly 40 is deenergized, check 76 remains seated because the hydraulic forces applied to the check are countered by the high pressure fuel provided to the first control chamber via branch passage 37 and check control line 36. Additionally, check spring 88 is positioned such that it biases check 76 downward toward its closed or first position.

When injection is desired, control valve assembly 40 is energized. Specifically, the electrical actuator 44 is energized, causing armature 46 and piston 45 to overcome the force of biasing spring 48 and lift. Control valve member 42 is then moved to its upper position or high-pressure seat by the upward force applied by biasing spring 49. In this position, pressurized fuel from control valve supply line 38 is no longer in fluid communication with check control line 36. Instead, check control line 36 is now in fluid communication with drain passage 52. High-pressure fuel within the first check control chamber 84 vents to drain outlet 50 through the a-orifice 55. At the same time, high-pressure fuel is also being provided to the first check control chamber 84 via the z-orifice 57. The a-orifice 55 may be slightly larger than the z-orifice 57. Thus, fuel leaves the first check control chamber 84 faster than it is being provided thereto. This causes a pressure drop within the first check control chamber 84. At the same time, pressurized fuel is still being provided to nozzle cavity 90 via nozzle passage 34. Because of the drop of pressure in the first check control chamber 84, the pressure in the nozzle cavity 90 than that of the first control chamber. The higher pressure in the nozzle chamber now applies hydraulic forces to the various surfaces of the check 76 causing it to lift off of seat 92. As the check 76 is unseated, pressurized fuel is injected into a combustion chamber (not shown) through the tip 94. More specifically, the pressurized fuel is injected through at least one orifice 96 in the tip 94.

The speed at which check 76 raises determines how much and how quickly fuel is delivered to a combustion chamber. In normal common rail injectors without a check speed control device of some type, the check 76 opens fully almost immediately, thereby providing a square shaped main injection curve as shown by curve 98 in FIG. 5. However, the injector embodied in FIGS. 2-4, has a ramped shaped delivery as shown by ramp shaped main injection curve 100. This desirable ramped shaped main injection curve 100 is provided because high pressure fuel in the second check control chamber 86 prevents the check 76 from opening fully too quickly. Specifically, as the check 76 is raised, the high-pressure fuel in the second check control chamber 86 has nowhere to go except to press check speed control device 56 against the top of the cavity 58. Biasing spring 74 also works to press check speed control device 56 against the top of cavity 58. With check speed control device pressed against the top of cavity 58, the pressurized fuel in the second check control chamber 86, still seeking a place to escape, then squeezes out orifice 72 and ultimately out the a-orifice 55 to drain outlet 50. The bottleneck caused by orifice 72 prevents check 76 from opening fully too quickly. Thus, a ramped shaped main injection curve 100 is produced.

When it is desirable to stop injection, electrical actuator 44 is deenergized. As the electromagnetic field generated by electrical actuator 44 dissipates, the force of biasing spring 48 acts on piston 45 and armature 46. As piston 45 applies a downward force on control valve member 42, the force of the smaller biasing spring 49 is overcome and control valve member 42 is returned to close the low pressure seat. When the control valve member 42 is on the low pressure seat, the check control line 36 is once again in fluid communication with the high pressure fuel supply passage 32. Ultimately, the first and second check control chambers, 84, 86 are refilled with pressurized fuel, and the injector 22 is once again ready for an injection event.

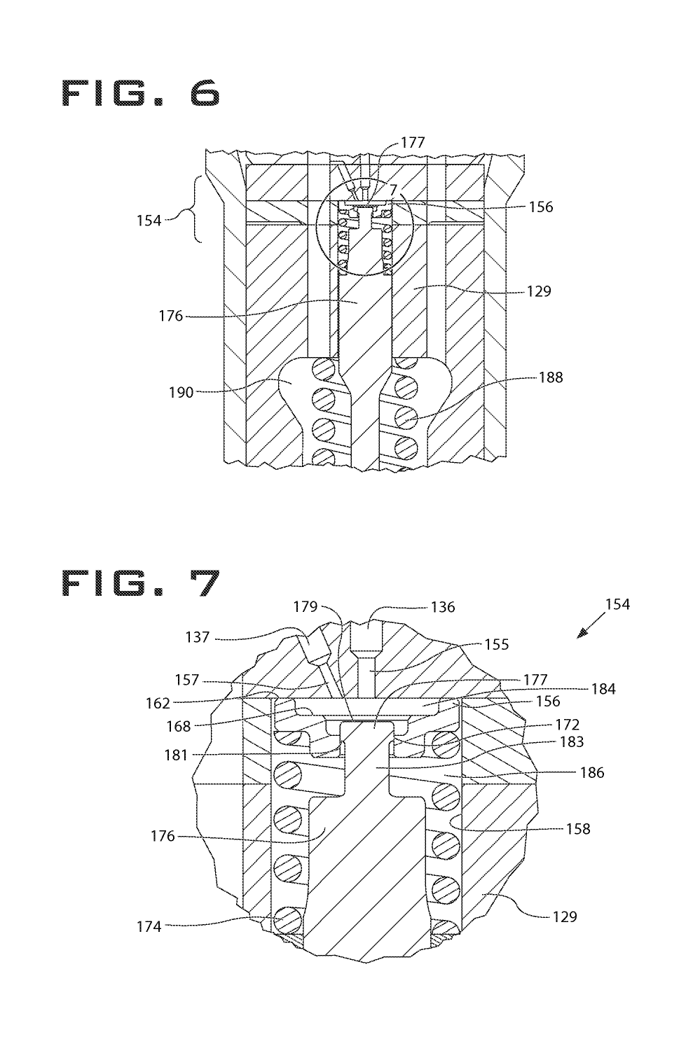

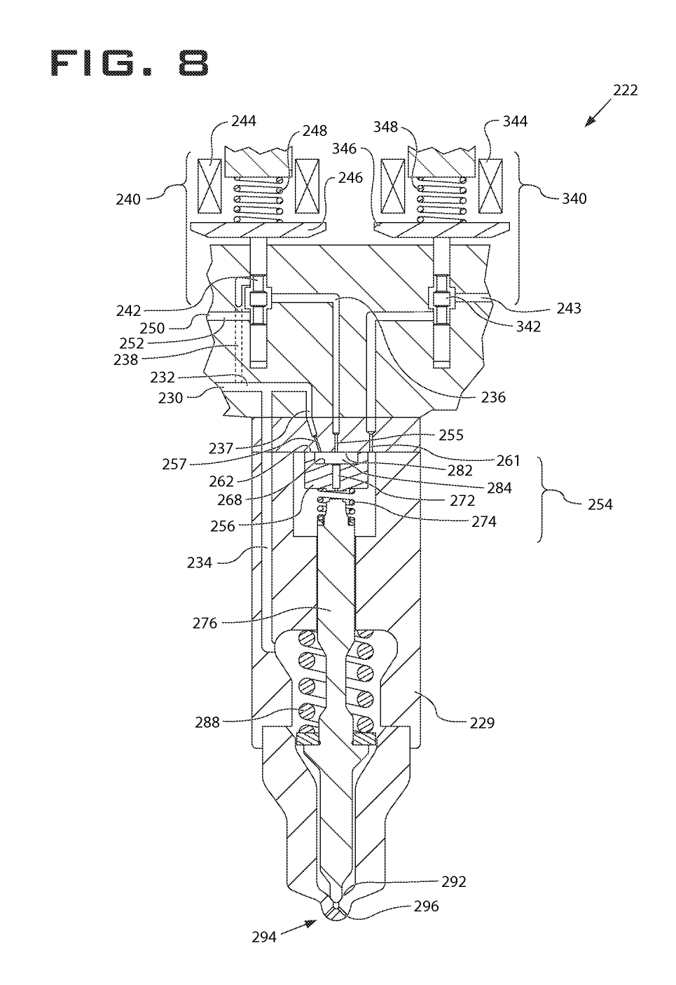

Referring now to FIGS. 6 and 7, which depict an alternative embodiment of the check speed control assembly 154, check control line 136 and high-pressure branch passage 137, are fluidly connected to a check speed control assembly 154 via an a-orifice 155 and a z-orifice 157, respectively. Check speed control assembly 154 includes a check speed control device 156 disposed within a cavity 158 defined by injector body 129. Check speed control device 156 may be generally disc-shaped and may include an upper raised surface or lip 162 around its periphery. Lip 162 has a predetermined width and is raised a predetermined height from an upper surface 168. Upper surface 168 has an orifice 172 that is capable of providing fluid communication through the check speed control device 156. It is contemplated that the orifice 172 may be restricted or tapered such that it is wider at its top than at its bottom. In the embodiment shown in FIGS. 6 and 7, orifice 172 is wide enough so that a head 177 of check 176 may be movably disposed therein with little to no clearance. The head 177 may be generally disc shaped and have an upper surface 179 and a lower surface 181. Head 177 may be of a predetermined thickness that is approximately equal to the length of orifice 172. Head 177 may sit atop a tapered neck 183 that has a diameter smaller than that of the head 177. Because of the tapered nature of neck 183, the outer portion of the lower surface 181 forms a flange that acts as a hydraulic surface. Although not shown, it is contemplated that check speed control device 156 may also have one or more radial guides with a similar shape and function as those depicted in FIG. 4. As will be apparent to those skilled in the art, the shape of head 177 does not have to be disc like in nature. Head 177 may be any of a myriad of shapes so long as orifice 172 is shaped to match.

The check speed control assembly 154 may also include a biasing spring 174 disposed between a check 176 and the check speed control device 156. The biasing spring 174 biases the check speed control device 156 in an upward direction such that the lip 162 of the check speed control device 156 is in contact with the upper surface 182 of cavity 158. A first check control chamber 184 is defined by the upper surface 182 of the cavity 158 and the upper surface 168 of the check speed control device 156. A second check control chamber 186 is defined by the bottom surface 180 of the check speed control device 156 and the space of cavity 158 above check 176.

During an injection event, the embodiment of the check speed control device 156 depicted in FIGS. 6 and 7 operates in a manner similar to the previously disclosed embodiments. In general, check speed control device 156 operates to prevent check 176 from opening fully too quickly. During injection, fuel is allowed to flow out of the a-orifice 155 to drain outlet (not shown). This relieves the pressure within the first check control chamber 184. As this is happening, pressure within the nozzle cavity 190 builds and applies force on the hydraulic opening surfaces of check 176. The force applied to check 176 is sufficient to overcome the downward force of check spring 188, thereby causing check 176 to unseat. As check 176 unseats fuel is injected into the combustion chamber (not shown).

As check 176 is raised, the high-pressure fuel in the second check control chamber 186 has nowhere to go except to press check speed control device 156 against the top of the cavity 158. Biasing spring 174 also works to press check speed control device 156 against the top of cavity 158. With check speed control device pressed against the top of cavity 158, the pressurized fuel in the second check control chamber 186, still seeking a place to escape, then applies force on the lower surface 181 of head 177. As the head 177 is pressed upward through orifice 172 the overall speed of check 176 is slowed down and the check 176 is prevented from opening fully too quickly. Thus, the desired ramped shaped main injection curve 100 may be produced.

In yet another embodiment, as shown in FIG. 8, an injector 222 with increased rate shaping flexibility is disclosed. Injector 222 may have an internal structure and fluid circuitry similar to the injector disclosed in FIG. 2, with the exception that this embodiment has a second valve control assembly 340. In particular, an injector body 229 defines a high-pressure fuel supply inlet 230 and a fuel supply passage 232, which are interconnected. Fuel supply passage 232 is in fluid communication with nozzle passage 234. Fuel supply passage 232 is also in fluid communication with check control line 236 via control valve supply line 238 and a first control valve assembly 240.

In the embodiment disclosed, first control valve assembly 240 is a three way valve that includes a control valve member 242 that moves between a low pressure seat (not shown) and high pressure seat (not shown). In the embodiment shown, control valve member 242 is coupled to an armature 246. Armature 246 is operably coupled to electrical actuator 244, through armature 246. Control valve member 242 and armature 246 are normally biased downward by a biasing spring 248. When control valve member 242 is in a downward position closing low pressure seat, check control line 236 is in fluid communication with fuel supply passage 232 via control valve supply line 238. When electrical actuator 244 is energized, the electromagnetic field generated by the electrical actuator 244 causes armature 246 and control valve member 242 to lift by overcoming the downward force applied by biasing spring 248. During the energized state, control valve member 242 lifts upwards to close high pressure seat, such that check control line 236 is fluidly connected to drain outlet 250 via drain passage 252. It will be appreciated by those skilled in the art that first control valve assembly 240 could have many alternate embodiments without deviating from the spirit of this disclosure. These alternate embodiments may include piezo actuation and other armature, spring, and control valve member configurations.

Check control line 236 and high-pressure branch passage 237, are fluidly connected to a check speed control assembly 254 via an a-orifice 255 and a z-orifice 257, respectively. Check speed control assembly 254 includes a check speed control device 256 disposed within a cavity 258 defined by injector body 229. Check speed control device 256 may be generally disc-shaped and may include an upper raised surface or lip 262 around its periphery. Lip 262 has a predetermined width and is raised a predetermined height from an upper surface 268. Upper surface 268 has an orifice 272 that is capable of providing fluid communication through the check speed control device 256.

The check speed control assembly 254 may also include a biasing spring 274 disposed between a check valve 276 and the check speed control device 256. The biasing spring 274 biases the check speed control device 256 in an upward direction such that the lip 262 of the check speed control device 256 is in contact with the upper surface 282 of cavity 258. A first check control chamber 284 is defined by the upper surface 282 of the cavity 258 and the upper surface 268 of the check speed control device 256. A second check control chamber 286 is defined by the bottom surface 280 of the check speed control device 256 and the space of cavity 258 above check 276.

In this embodiment, the second check control chamber 286 is fluidly coupled to a drain outlet 243 via an s-orifice 261, a vent passage 247 and the second control valve assembly 340. The second control valve assembly 340 may be a two way valve including a control valve member 342 coupled to an armature 346. Armature 346 is operably coupled to an electrical actuator 344. Control valve member 342 and electrical actuator 344 are normally biased downward by a biasing spring 348. Because second control valve assembly 340 is a simple two way valve, when control valve member 342 is in a downward position there is no fluid communication between vent passage 247 and drain outlet 243. Conversely, when electrical actuator 344 is energized, and armature 346 and control valve member 342 are lifted, fluid communication between vent passage 247 and drain outlet 243 is established. It will be appreciated by those skilled in the art that control valve assembly may have alternate embodiments without deviating from the scope and spirit of this disclosure. Likewise, it will be appreciated that drain outlet 243 may be routed within injector to be either separate or coincide with drain outlet 250.

Common rail injectors naturally produce square shaped delivery curves. The addition of a check speed control device such as that disclosed herein changes the natural injection profile of a common rail injector from square to ramped. However, there are times when it may be desirable for a common rail injector to provide a square shaped fuel delivery profile. For example, it is believed that injections that produce square shaped post injection curves 101 may help to reduce smoke. (See FIG. 5). Thus, it may be desirable to inject fuel in a manner that produces a ramped shaped main injection curve 100 and a square shaped post injection curves 101. The addition of the second control valve assembly 340 allows for increased flexibility with respect to the rate shape of fuel delivered to a combustion chamber. The disclosed injector 222 can perform both square and ramped shaped injections.

Those skilled in the art will appreciate that when the first control valve assembly 240 is energized and the second control valve assembly 340 is not energized that injector 222 will function virtually identically to the previously disclosed and described injector 22. Thus, a ramped shaped delivery curve will be obtained.

The production of a square shaped main injection curve 98 or a square shaped post injection curve 101 using injector 222 will now be explained. When injection is desired, first control valve assembly 240 is energized. Specifically, the electrical actuator 244 is energized, causing armature 246 and control valve member 242 to overcome the force of biasing spring 248 and lift. Control valve member 242 is now in its upper position or high-pressure seat. In this position, pressurized fuel from control valve supply line 238 is no longer in fluid communication with check control line 236. Instead, check control line 236 is now in fluid communication with drain passage 252. High-pressure fuel within the first check control chamber 284 vents to drain outlet 250 through the a-orifice 255. At the same time, high-pressure fuel is also being provided to the first check control chamber 284 via the z-orifice 257. The a-orifice 255 may be slightly larger than the z-orifice 257. Thus, fuel leaves the first check control chamber 284 faster than it is being provided thereto. This causes a pressure drop within the first check control chamber 284. At the same time, pressurized fuel is still being provided to nozzle chamber 290 via nozzle line 234. Because of the drop of pressure in the first check control chamber 284, the pressure in the nozzle chamber 290 than that of the first control chamber. The higher pressure in the nozzle chamber now applies hydraulic forces to the various surfaces of the check 276 causing it to lift off of seat 292. As the check 276 is unseated, pressurized fuel is injected into a combustion chamber (not shown) through the tip 294. More specifically, the pressurized fuel is injected through at least one orifice 296 in the tip 294.

As previously disclosed, a ramped shaped curve is achieved because the pressurized fuel in the second check control chamber 286 is bottlenecked when seeking to escape through a relatively small orifice 272. However, when the second control valve assembly 340 is energized, fluid communication between vent passage 247 and drain outlet 243 is established. Thus, the pressurized fuel in the second check control chamber 286 that would otherwise be bottlenecked at orifice 272 is now free to flow out of the s-orifice 261; into the vent passage; and ultimately out drain 243. In the absence of pressurized fuel in the second check control chamber 286, there is nothing preventing check 276 from quickly opening fully. Thus, a square shaped post injection curve 101 is produced.

### INDUSTRIAL APPLICABILITY

The present disclosure finds a preferred application in common rail fuel injection systems. In addition the present disclosure finds preferred application in single fluid, namely fuel injection, systems. Although the disclosure is illustrated in the context of a compression ignition engine, the disclosure could find application in other engine applications, including but not limited to spark ignited engines. The disclosed fuel injectors have the capability of producing ramp injection shapes, square injection shapes, split injections, and relatively abrupt injection endings. Furthermore, these different injection profiles can be selected independent of engine operating condition. Finally, like many electronically controlled fuel injection systems, the fuel injectors 22, 222 have relatively precise control over injection timing and quantity, which can be selected independent of engine speed and crank angle.

A ramp shaped main injection curve 100 and a square shaped post injection curve 101 may be achieved using a common rail injector 222. When a ramped shaped main injection curve 100 is desired first control valve assembly 240 is energized while second control valve assembly 340 remains unenergized. Specifically, the electrical actuator 244 is energized, causing armature 46 and control valve member 242 to overcome the force of biasing spring 248 and lift. Control valve member 242 is now in its upper position or high-pressure seat. In this position, pressurized fuel from control valve supply line 238 is in fluid communication with drain passage 252. High-pressure fuel within the first check control chamber 284 vents to drain outlet 250 through the a-orifice 255. At the same time, high-pressure fuel is also being provided to the first check control chamber 284 via the z-orifice 257. The a-orifice 255 may be slightly larger than the z-orifice 257. Thus, fuel leaves the first check control chamber 284 faster than it is being provided thereto. This causes a pressure drop within the first check control chamber 284. At the same time, pressurized fuel is still being provided to nozzle chamber 290 via nozzle line 234. Because of the drop of pressure in the first check control chamber 284, the pressure in the nozzle chamber 290 than that of the first control chamber. The higher pressure in the nozzle chamber now applies hydraulic forces to the various surfaces of the check 276 causing it to lift off of seat 292. As the check 276 is unseated, pressurized fuel is injected into a combustion chamber (not shown) through the tip 294. More specifically, the pressurized fuel is injected through at least one orifice 296 in the tip 294.

A ramped shaped main injection curve 100 is provided because high-pressure fuel in the second check control chamber 286 prevents the check 276 from opening fully too quickly. Specifically, as the check 276 is raised, the high-pressure fuel in the second check control chamber 286 has nowhere to go except to press check speed control device 256 against the top of the cavity 258. Those skilled in the art will recognize that pressurized fuel within the second check control chamber 286 cannot escape through the s-orifice 261 because second control valve assembly 340 is not energized. Thus, there is no fluid communication between the second check control chamber 286 and drain outlet 243. With check speed control device 256 pressed against the top of cavity 258, the pressurized fuel in the second check control chamber 286, still seeking a place to escape, then squeezes out orifice 272 and ultimately out the a-orifice 255 to drain outlet 250. The bottleneck caused by orifice 272 prevents check 276 from opening fully too quickly. Thus, a ramped shaped main injection curve 100 is produced.

Deenergizing electrical actuator 244 ends the main injection. As the electromagnetic field generated by electrical actuator 244 dissipates, control valve member 242 is returned to close the low-pressure seat (not shown). When the control valve member 242 is on the low-pressure seat, the check control line 236 is once again in fluid communication with the high-pressure fuel supply passage 232. Ultimately, the first and second check control chambers, 284, 286 are refilled with pressurized fuel, and the injector 222 is once again ready for an injection event.

A square shaped post injection curve 101 may be achieved by simultaneously actuating control valve assemblies 240 and 340. The actuation of control valve assembly 240 raises check valve member to its high-pressure seat and thus establishes fluid communication between the first check control chamber 284 and drain outlet 250. Pressurized fuel within the first check control chamber 284 is allowed to escape through the a-orifice 255. At the same time, the actuation of second control valve assembly 340 raises control valve member 342 to its open position. Thus fluid communication is established between the second check control chamber 286 and drain outlet 243. Pressurized fuel is now allowed to escape through the s-orifice 261.

As pressurized fuel is allowed to escape from the first and second check control chambers 284, 286, high-pressure fuel is continually delivered to nozzle chamber 290. As the pressure builds in nozzle chamber 290 force is applied to the hydraulic opening surfaces of check 276 thereby causing check 276 to lift. As the check 276 is unseated, pressurized fuel is injected into a combustion chamber (not shown) through the tip 294. More specifically, the pressurized fuel is injected through at least one orifice 296 in the tip 294. Check 276 quickly opens fully because there is little to no counterbalancing pressure in the first and second check control chambers 284, 286. Because check 276 quickly opens fully, a square shaped post injection curve 101 is delivered.

The above description is intended for illustrative purposes only and is not intended to limit the scope of the present disclosure in any way. Thus, those skilled in the art will appreciate the various modifications that can be made to the illustrated embodiments without departing from the spirit and scope of the disclosure, which is defined in the terms of the claims set forth below.

What is claimed is:

1. A fluid injector comprising:
an injector body defining a high pressure inlet, a nozzle supply passage, a low pressure drain and at least one nozzle outlet;
a check speed control device having an upper surface, lower surface and orifice positioned within a cavity of the fluid injector having an upper surface and a lower surface, wherein the space between the upper surface of the check speed control device and upper surface of the cavity defines a first check control chamber, and the space defined by the lower surface of the check speed control device and the lower surface of the cavity defines a second check control chamber, the first and second check control chambers being in fluid communication with one another via the orifice;
wherein the check speed control device is movable within the cavity between a first speed control position wherein at least a portion of the upper surface of the check speed control device is in contact with the upper surface of the cavity and a second speed control position wherein at least a portion of the upper surface of the check speed control device is spaced away from the upper surface of the cavity;
a control valve assembly having a valve member configured to selectively connect the high pressure inlet, the low pressure drain and first check control chamber; and
a check movable within the fluid injector between a first check position at which the check blocks the at least one nozzle outlet and a second check position at which the check at least partially opens the at least one nozzle outlet, the check including at least one opening hydraulic surface exposed to a fluid pressure of the nozzle supply passage and at least one closing hydraulic surface exposed to a fluid pressure of the second check control chamber.

2. The fluid injector of claim 1, wherein the check includes a first check end which blocks the at least one nozzle outlet at the first check position and a second check end whereupon the at least one closing hydraulic surface is disposed.

3. The fluid injector of claim 2, wherein the check speed control device is disposed atop a biasing spring that biases the check speed control device to the first speed control position.

4. The fluid injector of claim 3, wherein the check speed control device further includes at least one interrupted radial edge that spaces the check speed control device away from a side surface of the cavity, and wherein the first and second control chambers are in fluid communication with one another via the interruption when the check speed control device is in the second speed control position.

5. The fluid injector of claim 4, further comprising a second control valve assembly having a valve member configured to selectively connect the high pressure inlet, the low pressure drain and the second check control chamber.

6. The fluid injector of claim 4, wherein at least a portion of the second check end is disposed within the orifice when the check is in the first check position, and within the first check control chamber when the check is in the second check position.

7. The fluid injector of claim 5, further comprising a second control valve assembly having a valve member configured to selectively connect the high pressure inlet, the low pressure drain and the second check control chamber.

8. A method of controlling a speed of a check in a fluid injector comprising the steps of:
providing a fluid injector having a cavity wherein said cavity includes an upper surface and a lower surface, and providing a check speed control device positioned within the cavity wherein said check speed control device includes an upper surface, lower surface and an orifice; and wherein the space between the upper surface of the check speed control device and the upper surface of the cavity defines a first check control chamber and the space defined by the lower surface of the check speed control device and the lower surface of the cavity defines a second check control chamber, and the first check control chamber and second check control chamber are fluidly connected to one another via the orifice; and wherein the check speed control device is movable within the cavity between a first speed control position wherein at least a portion of the upper surface of the check speed control device is in contact with the upper surface of the cavity and a second speed control position wherein at least a portion of the upper surface of the check speed control device is spaced away from the upper surface of the cavity;
providing a check having a first check end and a second check end, wherein said check is movable a check travel distance defined as a distance between a first check position wherein the first check end blocks a nozzle outlet of the fluid injector, and a second check position at which the first check end at least partially opens the nozzle outlet; and wherein said second check end includes at least one closing hydraulic surface; and wherein the second check end is exposed to a fluid pressure of the second check control chamber; and
limiting a speed of the check over the check travel distance with the check speed control device by controlling the rate of fluid expelled from the cavity to a low pressure drain of the fluid injector.

9. The method of claim 8 wherein the step of limiting a speed is further controlled by a control valve assembly having a valve member configured to selectively connect a high pressure inlet of the fluid injector, the low pressure drain, and the first check control chamber.

10. The method of claim 9, wherein the check speed control device is disposed atop a biasing spring that biases the check speed control device to the first speed control position.

11. The method of claim 10, wherein the check speed control device further includes at least one interrupted radial edge that spaces the check speed control device away from a side surface of the cavity, and wherein the first and second control chambers are in fluid communication with one another via the interruption when the check speed control device is in the second speed control position.

12. The method of claim 11, wherein a least a portion of the second check end is disposed within the orifice of the check speed control device orifice when the check is in the first check position.

13. The method of claim 11, wherein the step of expelling fluid is further controlled by a second check control valve assembly having a valve member configured to selectively connect the high pressure inlet, the low pressure drain and the second check control chamber.

14. The method of claim 12, wherein the step of expelling fluid is further controlled by a second control valve assembly having a valve member configured to selectively connect the high pressure inlet, the low pressure drain and the second check control chamber.

15. An internal combustion engine comprising:
an engine housing defining a plurality of engine cylinders, and including a plurality of pistons each being movable within a corresponding one of the engine cylinders; and
a fuel system including a plurality of fuel injectors associated one with each of the plurality of engine cylinders, each of the fuel injectors including a cavity having an upper surface and a lower surface, and having a check speed control device having an upper and lower surface and an orifice positioned therein;
wherein the space between the upper surface of the check speed control device and the upper surface of the cavity defines a first check control chamber and the space defined by the lower surface of the check speed control device and the lower surface of the cavity defines a second check control chamber, and the first and second check control chambers are fluidly connected to one another via the orifice; and
each of the plurality of fuel injectors further including a check movable a check travel distance to control an injection of fuel into the associated engine cylinder and having at least one closing hydraulic surface exposed to a fluid pressure of the second check control chamber.

16. The internal combustion engine of claim 15, wherein each of the plurality of fuel injectors includes a high pressure fuel inlet connecting with at least one of the corresponding first check control chamber and second check control chamber, a nozzle supply passage connecting the high pressure fuel inlet and an at least one nozzle outlet, and wherein the check of each one of the fuel injectors includes at least one opening hydraulic surface exposed to a fluid pressure of the corresponding nozzle supply passage.

17. The internal combustion engine of claim 16 further comprising a high pressure fuel pump and a common rail fluidly connected with the high pressure fuel pump and with the high pressure fuel inlet of each one of the plurality of fuel injectors.

18. The internal combustion engine of claim 17 further comprising a compression ignition diesel engine, and wherein each one of the fuel injectors includes a nozzle tip extending into a corresponding one of the plurality of engine cylinders.
